(19) United States
(12) Patent Application Publication
(10) Pub. No.: US 2015/0078454 A1
(43) Pub. Date: Mar. 19, 2015

(54) METHOD AND DEVICE FOR CODING AND DECODING IMAGES

(71) Applicant: Orange, Paris (FR)

(72) Inventors: Felix Henry, Saint Gregoire (FR); Stéphane Pateux, Rennes (FR); Gordon Clare, Pace (FR)

(73) Assignee: Orange, Paris (FR)

(21) Appl. No.: 14/388,658

(22) PCT Filed: Mar. 6, 2013
(86) PCT No.: PCT/FR2013/050474

§ 371 Date: Sep. 26, 2014

(30) Foreign Application Priority Data
Mar. 29, 2012 (FR) 1252826

(51) Int. Cl. H04N 19/91; H04N 19/44

(52) U.S. Cl. CPC H04N 19/91; H04N 19/44
USPC 375/240.24

(57) ABSTRACT

A coding method includes cutting an image into a plurality of blocks containing symbols. Adjacent pairs of blocks are grouped into a predetermined number of tiles of the image. An entropy coder codes each tile by associating digital information with the symbols of each block of a tile under consideration, Coding includes, for the first block of the image, a substep of initializing state variables of the entropy coder. At least one data substream is generated and representative of at least one of the coded tiles. When the current block of the tile forms a boundary with an adjacent edge of a neighboring tile, the method includes writing in the substream all of the digital information that has been associated with the symbols during the coding, for the tile under consideration, of the blocks preceding the current block, and performing the initialization substep.

### CROSS-REFERENCE TO RELATED APPLICATIONS

This application is a Section 371 National Stage Application of International Application No. PCT/FR2013/050474, filed Mar. 6, 2013, the content of which is incorporated herein by reference in its entirety, and published as WO 2013/144474 on Oct. 3, 3013, not in English.

### FIELD OF THE INVENTION

The present invention relates in general to the field of processing images, and more precisely to coding and decoding digital images and sequences of digital images.

The invention can thus be applied in particular to the video coding performed in present video coders (MPEG, H.264, etc.) or future video coders (ITU-T/VCEG (HEVC) or ISO/MPEG (HVC)).

### BACKGROUND OF THE INVENTION

The HEVC standard that is currently being prepared and that is described in the document “Joint collaborative team on video coding (JCT-VC) of ITU-T SG16 WP3 and ISO/IEC JTC1/SC29/WG11 7th Meeting: Geneva, CH, Nov. 21-30, 2011” is similar to the preceding H.264 standard in the sense that it uses a block representation of the video sequence. Nevertheless, the HEVC standard differs from the H.264 standard by the fact that it subdivides the image into a plurality of block partitions referred to as “tiles”, as described in the document “Joint collaborative team on video coding (JCT-VC) of ITU-T SG16 WP3 and ISO/IEC JTC1/SC29/WG11 6th Meeting: Torino, IT, Jul. 14-22, 2011”.

More precisely, such a subdivision consists in partitioning each image of the video with the help of one or more vertical boundaries extending from top to bottom of the image and one or more horizontal boundaries extending from one side (e.g. left side) to the other (e.g. right side) of the image. The macroblocks lying between two consecutive vertical boundaries and two consecutive horizontal boundaries form a tile in which neighboring pairs of macroblocks are thus grouped together. Within a tile, the macroblocks are coded and then decoded in a lexicographical order, i.e. using a row by row scan through the blocks of the raster-scan type, starting the block situated at the top left corner of the tile and going to the block situated at the bottom right corner of the tile. The tiles are themselves coded and then decoded in lexicographical order. FIG. 1 shows an example of an image IMG subdivided into a predetermined number of tiles, e.g. nine tiles T1 to T9. In the example shown:
the tile T1 comprises macroblocks MB1 to MB9;
the tile T2 comprises macroblocks MB10 to MB15;
the tile T3 comprises macroblocks MB16 to MB24;
the tile T4 comprises macroblocks MB25 to MB30;
the tile T5 comprises macroblocks MB31 to MB34;
the tile T6 comprises macroblocks MB35 to MB40;
the tile T7 comprises macroblocks MB41 to MB43;
the tile T8 comprises macroblocks MB44 to MB45;
the tile T9 comprises macroblocks MB46 to MB48.

The set of tiles T1, T4, and T7 is separated from the set of tiles T2, T5, and T8 by a vertical boundary F1.

The set of tiles T2, T5, and T8 is separated from the set of tiles T3, T6, and T9 by a vertical boundary F2.

The set of tiles T1, T2, and T3 is separated from the set of tiles T4, T5, and T6 by a horizontal boundary F3.

The set of tiles T4, T5, and T6 is separated from the set of tiles T7, T8, and T9 by a horizontal boundary F4.

The numbers and sizes of the tiles are parameters that can be set image by image. The macroblocks are numbered in the “raster-scan” order in which they are processed in the tile in question, as explained above.

The advantage of subdividing into tiles in this way is that the intra or inter prediction is not authorized for a macroblock of a tile in question, e.g. the macroblock MB10 of the tile T2, relative to a macroblock that has already been coded and then decoded and that belongs to a tile other than the tile T2, e.g. the macroblock MB3 of the tile T1. Consequently, each tile may be encoded and then decoded independently, thus enabling these tiles to be encoded and/or decoded in parallel on different processor units, with each unit processing one tile.

As in the H.264 standard, the above-mentioned HEVC standard proposes that for each macroblock under consideration for coding, a residual macroblock may be coded corresponding to the original macroblock minus a prediction. Such a residual macroblock contains coefficients that are quantified after optional transform, and then coded by an entropy coder.

Attention is given herein more particularly to the entropy coder. An entropy coder codes information in its order of arrival. Typically, the blocks are passed through row by row with a raster-scan type, starting from the top left block of the image. For each block, the information needed for representing the block (type of block, prediction mode, residual coefficients, . . . ) is sent sequentially to the entropy coder.

An arithmetic coder that is effective and of reasonable complexity is already known, it is referred to as a “context adaptive binary arithmetic coder” (CABAC) and it was introduced in the AVC compression standard (also known as ISO-MPEG4 part 10 and ITU-T H.264).

That entropy coder implements various concepts:
arithmetic symbol coding based on using the probability of the symbol appearing, i.e. its “appearance probability”;
adaptation to context: here adapting to the appearance probabilities of symbols for coding. Firstly training is performed on the fly. Secondly, depending on the state of the previously coded information, a specific context is used for the coding. Each context corresponds to an appearance probability specific to the symbol. For example, a context corresponds to a type of coded symbol (the representation of a residual coefficient, signaling the coding mode, . . . ) in a given configuration, or a neighborhood state (e.g. the number of “intra” modes selected in the neighborhood, . . . ); and
binarizing: symbols for coding are put into the form of a sequence of bits. Thereafter, the various bits are sent in succession to the binary entropy coder.

Thus, for each context used, the entropy coder makes use of a system for learning probabilities on the fly relative to the previously coded symbols for the context under consideration. This learning is based on the coding order of the symbols. When entropy coding of a current macroblock begins, the symbol appearance probabilities that are used are those obtained after coding a previously coded and then decoded macroblock, which is the macroblock immediately preceding the current block in the scan order through the blocks.

Such an entropy coder suffers from the drawback that the coding and decoding of a symbol depend on the probability state as learnt so far, so symbols can be decoded only in the same order as that used during coding.

In the future HEVC standard, entropy coding is performed tile by tile in the raster-scan order of those tiles, rather than row by row.

Thus, in the example shown in FIG. 1, CABAC entropy coding is applied successively to the macroblocks MB1 to MB9 of the tile T1, to the macroblocks MB10 to MB15 of the tile T2, to the macroblocks MB16 to MB24 of the tile T3, to the macroblocks MB25 to MB30 of the tile T4, to the macroblocks MB31 to MB34 of the tile T5, to the macroblocks MB35 to MB40 of the tile T6, to the macroblocks MB41 to MB43 of the tile T7, to the macroblocks MB44 to MB45 of the tile T8, and finally to the macroblocks MB46 to MB48 of the tile T9.

It can be seen that it might nevertheless be advantageous to decode an image that has been coded after being subdivided into tiles, while nevertheless conserving the raster-scan order of the image rows as proposed in the H.264 standard rather than using the raster-scan order of the tiles. Such a provision is advantageous for the purpose of delivering pixel macroblock rows that are suitable for being displayed on display screens, since they generally make use of a horizontal scan of rows of pixels.

Consideration is given to an image IMG subdivided into tiles as shown in FIG. 1. As explained above, in the HEVC standard that is being prepared, the macroblocks are coded in the raster-scan order of each tile T1 to T9. The coding of each of the tiles generates a corresponding binary substream SFX1, SFX2, . . . , SFX9, each substream being arranged in a final compressed stream FX in the order in which the associated tile is processed. For simplification purposes, only the first three substreams SFX1, SFX2, and SFX3 are shown in FIG. 1. Each substream is then decoded in succession in the order in which it appears in the stream FX.

Nevertheless, for the above-mentioned reasons, it may be desirable to decode the image IMG in compliance with the H.264 standard, i.e. macroblock row by macroblock row in the image IMG, in the following order: MB1, MB2, MB3, MB10, MB11, MB16, MB17, MB18, MB4, MB5, MB6, MB12, MB13, MB19, MB20, MB21, and so on to macroblock MB48.

Since the macroblocks of the image IMG are decoded in the order defined by the tiles, in order to display the first row of macroblocks MB1, MB2, MB3, MB10, MB11, MB16, MB17, MB18, it is therefore necessary to decode all of the macroblocks MB1 to MB9 of the substream SFX1 before it is possible to begin decoding the macroblocks MB10 and MB11 of the substream SFX2. Likewise, it is necessary to decode all of the macroblocks MB10 to MB15 of the substream SFX2 before it is possible to begin decoding the macroblocks MB16, MB17, and MB18 of the substream SFX3. Thus, solely for the purpose of decoding the first row of macroblocks of the image, such a provision gives rise to considerable delay in decoding said first row and requires memory to be used to conserve all of the decoded pixels relating to the macroblocks MB1 to MB9 of the tile T1, to the macroblocks MB10 to MB15 of the tile T2, and to the macroblocks MB16 to MB24 of the tile T3, which consumes a large amount of memory. Consequently, it would be desirable:
to decode only the macroblocks MB1, MB2, MB3, MB10, MB11, MB16, MB17, and MB18 in order to display the first row of macroblocks;
to decode only the macroblocks MB4, MB5, MB6, MB12, MB13, MB19, MB20, and MB21 to display the second row of macroblocks; and
so on for the following rows of macroblocks in the image IMG.

For this purpose, consideration is given to decoding the first row of macroblocks in the image IMG. A stream pointer PO scans through the substream SFX1 so as to read the data making it possible to decode the macroblocks MB1, MB2, and MB3. Given the fact that the CABAC entropy decoder uses sharing of bits between consecutive macroblocks, when the pointer PO has scanned through sufficient bits to be able to decode the data of the macroblock MB3, it has also read some of the bits needed for decoding at least the following macroblock MB4, which bits are referred to as “shared” bits. The pointer PO then needs to “jump” to the beginning of the following substream SFX2 in order to decode the data of the macroblocks MB10 and MB11. Such a jump is possible since each substream possesses a start address that is written in the header of the complete stream FX. Before making this jump, the decoder must:
store the position of the pointer PO in a pointer memory MP1 so as to be able subsequently to scan once more through the substream SFX1 in order to continue reading the bits corresponding to the macroblocks MB4, MB5, and MB6 of the second row of the image IMG; and
store the shared bits in a bit memory BM1. The pointer PO then begins reading the bits of the substream SFX2 in order to decode the macroblocks MB10 and MB11. In a manner similar to that described above, the decoder must:
store the position of the pointer PO in a pointer memory MP2 in order to be able subsequently to scan once more through the substream SFX2 in order to continue reading the bits corresponding to the macroblocks MB12 and MB13 of the second row of the image IMG; and
store the shared bits in a bit memory BM2.

Such a procedure thus continues each time a tile boundary is crossed while decoding the first row of the image IMG.

When decoding of the first row of the image IMG has terminated, the second row of the image is decoded. The pointer PO is then restored to the value previously stored in the memory MP1, and the shared bits that are contained in the memory BM1 are transferred into the current memory of the CABAC decoder. It is thus possible to begin decoding the macroblock MB4. This procedure is also performed for decoding the macroblocks MB12 and MB13 of the substream SFX2 and the macroblocks MB19, MB20, and MB21 of the substream SFX3.

Thereafter, the decoding of the following rows of the image IMG is continued in compliance with the above-described procedure.

The decoding method of that procedure does not provide good performance and it is cumbersome to implement, given the multiple operations it needs to perform and the large amount of information it needs to process and store. That gives rise to a decoding method with processing time that is too long and that consumes excessive memory resources.

### SUMMARY OF THE INVENTION

An exemplary aspect of the present invention provides a coding method for coding at least one image comprising the steps of:
cutting up the image into a plurality of blocks suitable for containing symbols belonging to a predetermined set of symbols;
grouping together adjacent pairs of blocks into a predetermined number of partitions of the image that are referred to as tiles, the blocks of a tile under consideration being for coding consecutively;
using an entropy coder module to code each of the tiles of blocks by associating digital information with the symbols of each block of a tile under consideration, the coding step including, for the first block of the image, a substep of initializing state variables of said entropy coder module; and
generating at least one data substream representative of at least one of the coded tiles of blocks.

The method of the invention is remarkable in that, for at least one tile under consideration of the image, where the current block of the tile is a coded block situated along an edge of the tile forming a boundary with an adjacent edge of a tile neighboring the tile under consideration, it further comprises the following steps:
writing in the substream representative of the tile under consideration all of the digital information that has been associated with the symbols during the coding, for the tile under consideration, of the blocks preceding the current block; and
performing the initialization substep.

Coupling together the above-mentioned writing step and the step of reinitializing the entropy coder module enables a data stream to be produced that is coded in raster-scan order for each tile of blocks in the current image, while being particularly well adapted to decoding the blocks of the image row of blocks by row of blocks, during which method there is no need:
to store beforehand the bits that have been shared during the coding of the first row of blocks of a tile under consideration (or during coding of the first row of blocks of the following tile), for use in coding the blocks following the last block of the first row of said tile under consideration in raster-scan order (or for coding the blocks following the last block of the first row of said following tile in raster-scan order); nor
to transfer the shared bits into the current memory of the entropy coder when restarting the decoding of the second row of blocks of the tile under consideration (or when restarting coding of the second row of blocks of the following tile).

In a first example, the state variables of the entropy coder module comprise the two bounds of an interval representative of the appearance probability of a symbol from among the symbols in the predetermined set of symbols.

In a second example, the state variables of the entropy coder module comprise one bound together with the length of an interval representative of the appearance probability of a symbol from among the symbols in the predetermined set of symbols.

In a third example, the state variables of the entropy coder module are symbol strings contained in the translation table of an LWZ (Lempel-Ziv-Welch) entropy coder that is well known to the person skilled in the art, and, on Mar. 29, 2012, was described at the following Internet address: http://en.wikipedia.org/wiki/Lempel%E2%80%93Ziv%E2%80%93Welch

In a particular implementation, the boundary-forming edge of the tile is vertical.

Such a provision enables the coded stream to be decoded more easily by conserving raster-scan order for the rows of the image as proposed in the H.264 standard, rather than using the raster-scan order for the tiles. This makes it possible to reconstruct rows of pixel macroblocks that are suitable for being displayed on display screens that generally operate with horizontal scanning of rows of pixels.

Correspondingly, the invention also provides a device for coding at least one image, the device comprising:
means for cutting up the image into a plurality of blocks suitable for containing symbols belonging to a predetermined set of symbols;
means for grouping together adjacent pairs of blocks in a predetermined number of image partitions referred to as tiles, the blocks of a tile under consideration being for coding consecutively;
means for coding each of the tiles of blocks, the coding means comprising an entropy coder module suitable for associating digital information with the symbols of each block of a tile under consideration, the coding means including, for the first block of the image, initialization submeans for initializing state variables of the entropy coder module; and
means for generating at least one data substream representative of at least one of the coded tiles of blocks.

Such a coder device is remarkable in that it comprises, for at least one tile under consideration of the image:
write means that, in the event of the current block of the tile under consideration being a coded block situated along an edge of the tile forming a boundary with an adjacent edge of a tile neighboring the tile under consideration, are activated to write in the substream representative of the tile under consideration all of the digital information that has been associated with the symbols during the coding, for the tile under consideration, of the blocks preceding the current block; the initialization submeans also being activated to reinitialize the state variables of the entropy coder module.

Correspondingly, the invention also provides a method of decoding a stream representative of at least one coded image, the method comprising the following steps:
identifying in the above-specified stream a predetermined number of data substreams corresponding respectively to partitions of blocks of the image for decoding, which partitions are referred to as tiles, the blocks of a tile under consideration being image blocks that are adjacent in pairs and that have been grouped together and then coded consecutively, the above-mentioned blocks being adapted to contain symbols belonging to a predetermined set of symbols; and
decoding the tiles of blocks identified by means of an entropy decoder module, by reading digital information in at least one of the identified substreams, which digital information is associated with the symbols of each block of the tile corresponding to said at least one identified substream, the decoding step including, for the first block to be decoded of the image, an initialization substep of initializing state variables of the entropy decoder module.

Such a decoding method is remarkable in that for at least one substream for decoding corresponding to at least one tile of the image, in the event of the current block of the tile being a block previously decoded and identified as being situated along an edge of the tile forming a boundary with an adjacent edge of a tile adjacent to the tile, performing the initialization substep.

Such a provision enables the previously coded stream to be decoded in such a manner that the blocks of the stream are decoded one after another in raster-scan order, i.e. the order in which they are arranged in the image, and not from one substream to the following substream, in the raster-scan order in which they are arranged in tiles.

This provision is particularly advantageous when it is desired to display the image row of blocks by row of blocks in the raster-scan order of the blocks of the image, particularly in the context of displaying the image on a display screen, where such screens generally operate using horizontal scanning of pixel rows.

Furthermore, because the entropy decoder module is reinitialized each time a decoded block runs along a boundary between the tile being decoded and the following tile in raster-scan order, there is no need, for the purpose of restarting decoding of the second row of blocks of said tile, once the blocks of the first row of the following tile have been decoded to perform the following:
to store beforehand the bits that have been shared during the decoding of the first row of blocks of said tile (or during the decoding of the first row of blocks of said following tile), for the purpose of being used in decoding the blocks that follow the last block of the first row of said tile in raster-scan order (or for decoding the blocks that follow the last block of the first row of said following tile in raster-scan order); and
to transfer the shared bits into the current memory of the entropy decoder when restarting the coding of the second row of blocks of the tile (or when restarting the coding of the second row of blocks of the following tile).

This results in a decoding method that is less expensive in terms of calculation and that therefore executes more quickly.

In a particular implementation, the edge of the boundary-forming tile is vertical.

Correspondingly, the invention provides a decoder device for decoding a stream representative of at least one coded image, the device comprising:
means for identifying in the above-mentioned stream a predetermined number of data substreams corresponding respectively to partitions of blocks of the image for decoding, which partitions are referred to as tiles, the blocks of a tile under consideration being image blocks that are adjacent in pairs that have been grouped together and then coded consecutively, the above-mentioned blocks being adapted to contain symbols belonging to a predetermined set of symbols; and
decoder means for decoding the identified tiles of blocks, the decoding means comprising an entropy decoder module suitable for reading in at least one of the identified substreams digital information associated with the symbols of each block of the tile corresponding to said at least one identified substream, the decoder means including, for the first block for decoding of the image, initialization submeans for initializing state variables of said entropy decoder module.

Such a decoder device is remarkable in that, for at least one substream for decoding corresponding to at least one tile of the image, in the event of the current block of the tile being a block that has been previously decoded and identified as being situated along an edge of the tile forming a boundary with an adjacent edge of a tile adjacent to the tile, the initialization submeans are activated to reinitialize the state variables of the entropy decoder module.

The invention also provides a computer program having instructions for executing steps of the above coding or decoding method when the program is executed by a computer.

Such a program may use any programming language, and be in the form of source code, object code, or code intermediate between source code and object code, such as in a partially complied form, or in any other desirable form.

The invention also provides a computer readable data medium including computer program instructions as mentioned above.

The data medium may be any entity or device capable of storing the program. For example, such a medium may comprise storage means, such as a read only memory (ROM), e.g. a compact disk (CD) ROM, or a microelectronic circuit ROM, or indeed magnetic storage means, e.g. a floppy disk or a hard disk.

Furthermore, such a data medium may be a transmissible medium such as an electrical or optical signal suitable for being conveyed via an electric or optical cable, by radio, or by other means. The program of the invention may in particular be downloaded from an Internet type network.

Alternatively, such a data medium may be an integrated circuit in which the program is incorporated, the circuit being adapted to execute the method in question or to be used in the execution thereof.

The above-mentioned coder device, the decoder device, and the computer programs all present at least the same advantages as the advantages conferred by the coding method of the present invention.

### BRIEF DESCRIPTION OF THE DRAWINGS

Other characteristics and advantages appear on reading about preferred implementations described with reference to the figures, in which:

FIG. 1 shows a prior art image coding scheme;

FIG. 2A shows the main steps of the coding method of the invention;

FIG. 2B shows in detail the coding performed in the coding method of FIG. 2A;

FIG. 3 shows an embodiment of a coding device of the invention;

FIG. 4 shows an image coding/decoding scheme in a preferred implementation;

FIG. 5A shows the main steps of the decoding method of the invention;

FIG. 5B shows in detail the decoding performed in the decoding method of FIG. 5A; and

FIG. 6 shows an embodiment of a decoding device of the invention.

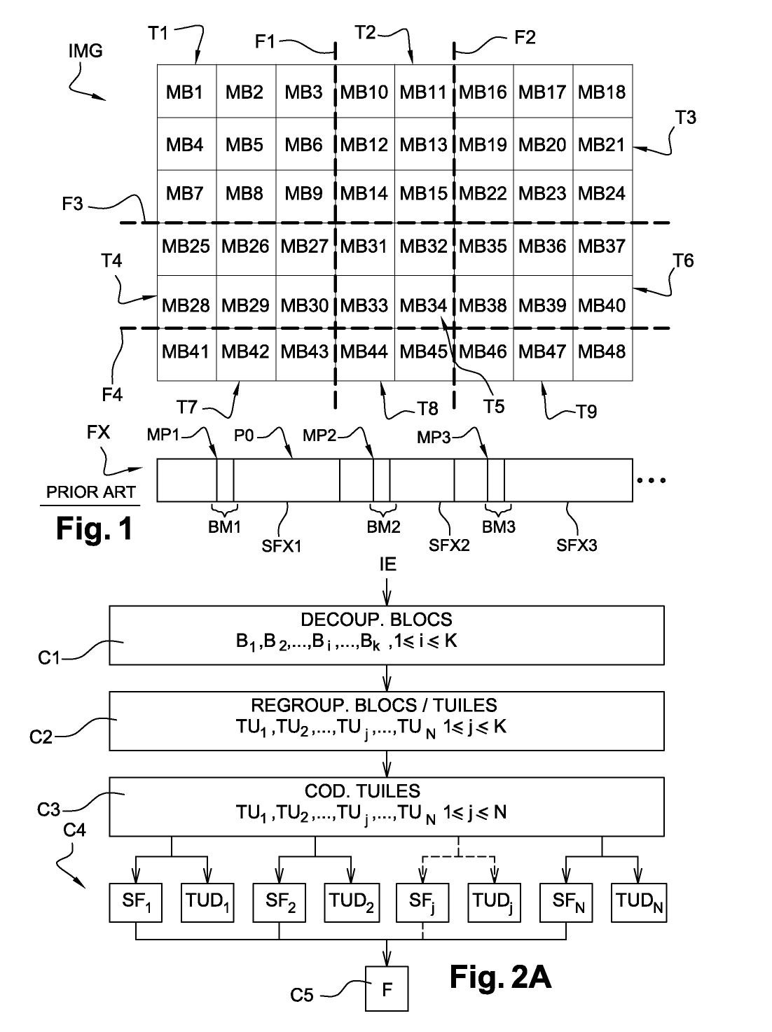

### DETAILED DESCRIPTION OF A FIRST IMPLEMENTATION OF THE CODING PORTION

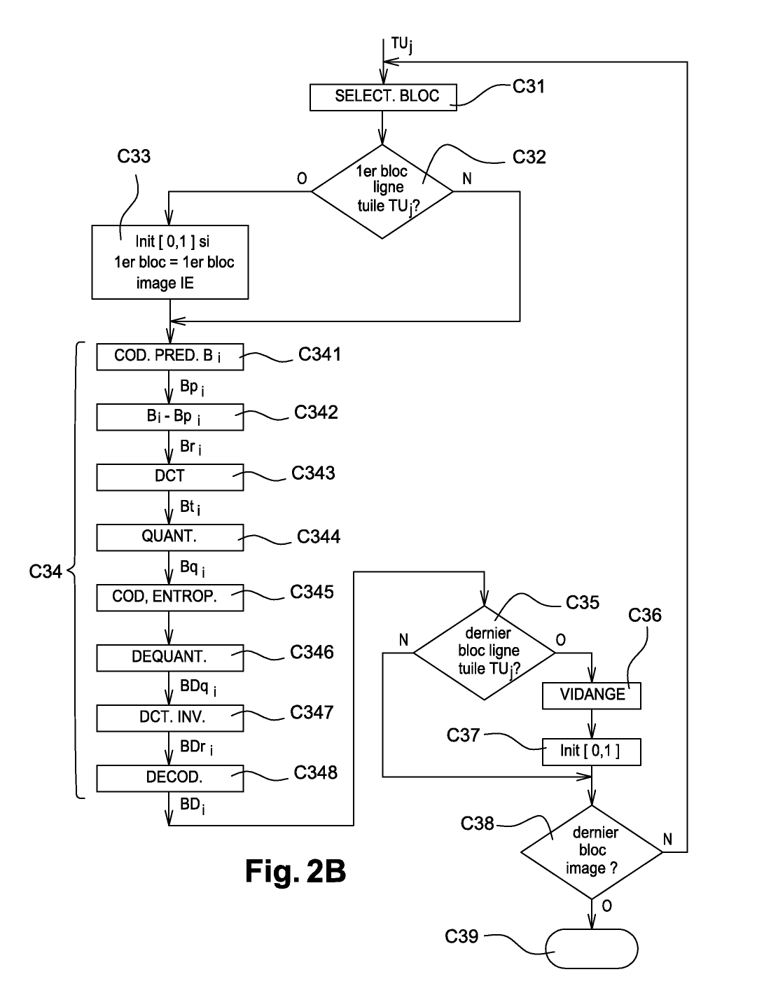

An implementation of the invention is described below, in which the coding method of the invention is used for coding a sequence of images in a binary stream close to that obtained by coding using the H.264/MPEG-4 AVC standard. In this implementation, the coding method of the invention is implemented for example in software or hardware form by modifying a coder initially in compliance with the H.264/MPEG-4 AVC standard. The coding method of the invention is described in the form of an algorithm having steps C1 to C5, as shown in FIG. 2A.

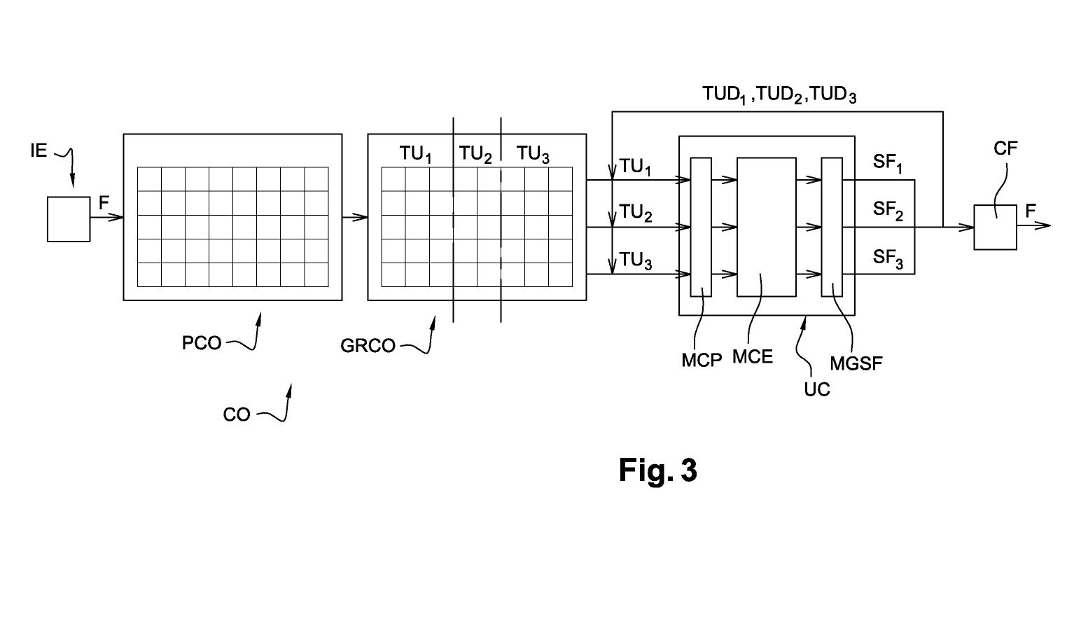

In the implementation of the invention, the coding method of the invention is implemented in a coding device CO, an embodiment of which is shown in FIG. 3.

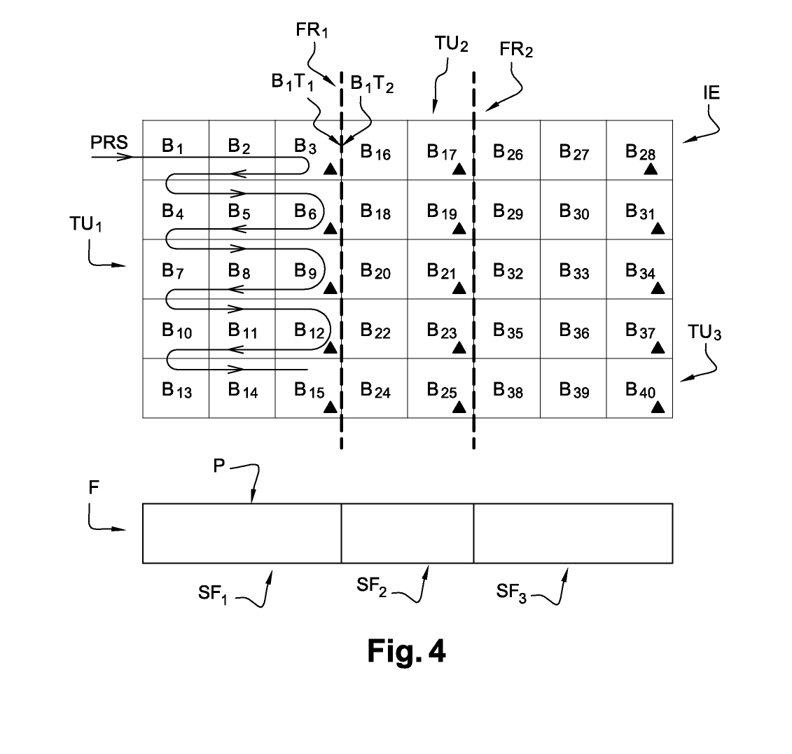

With reference to FIG. 2A, the first coding step C1 is cutting up an image IE of a sequence of images for coding into a plurality of blocks B₁, B₂, . . . , Bᵢ, . . . , B_{K}, with 1≦i≦K, as shown in FIG. 4. In the example shown, K=40. A macroblock is conventionally a block having a predetermined maximum size. Such a macroblock may also itself be cut up into smaller blocks. For simplification purposes, the term “block” is thus used both for specifying a block and for specifying a macroblock. Such blocks B₁, B₂, . . . , Bᵢ, . . . , B_{K}, are suitable for containing one or more symbols, said symbols forming part of a predetermined set of symbols. In the example shown, said blocks are square in shape and they are all of the same size. Depending on the size of the image, which is not necessarily a multiple of the size of the block, the last blocks to the left and the last blocks to the bottom need not be square. In an alternative implementation, the blocks may for example be rectangular in shape and/or they need not be in alignment with one another.

This cutting up is performed by a partitioning module PCO shown in FIG. 3, e.g. making use of a partitioning algorithm that is itself well known.

With reference to FIG. 2A, the second coding step C2 comprises grouping together adjacent pairs of the above-mentioned blocks into a predetermined number N of partitions of the image referred to as tiles TU₁, TU₂, . . . , TUⱼ, . . . , TU_{N}, with 1≦j≦N that are to be coded sequentially in raster-scan order, as explained above in the description of the prior art. In the example shown in FIG. 4, the blocks B₁ to B_{K} are grouped together to constitute N=3 tiles TU₁, TU₂, TU₃. For simplification purposes, subdivision into tiles is performed using only two vertical boundaries FR₁ and FR₂, without any horizontal boundaries. Naturally, the coding method also applies to subdividing the image using both vertical and horizontal boundaries or indeed using only horizontal boundaries, depending on the intended video application.

The two vertical boundaries FR₁ and FR₂ in the image IE define:
the first tile TU₁ containing the blocks B₁ to B₁₅;
the second tile TU₂ containing the blocks B₁₆ to B₂₅; and
the third tile TU₃ containing the blocks B₂₆ to B₄₀.

This grouping together is performed by a calculation module GRCO shown in FIG. 3, using an algorithm that is itself well known.

With reference to FIG. 2A, the third coding step C3 consists in coding each of the tiles of blocks TU₁, TU₂, . . . , TUⱼ, . . . , TU_{N} in raster-scan order, the blocks of a tile TUⱼ under consideration themselves being coded using a raster-scan order. In the example shown in FIG. 4, the tiles TU₁, TU₂, and TU₃ are coded one after another, the blocks of a current tile, e.g. the tile TU₁, being coded one after another, in raster-scan order, as represented by arrow PRS. For clarity in FIG. 4, the arrow PRS is not shown in the tiles TU₂ and TU₃.

According to the invention, such coding is for example of sequential type and is performed by a coding unit UC that codes successively in raster-scan order a number N of tiles for coding, with N=3 in the example shown in FIG. 3.

In known manner, the coding unit UC comprises:
a predictive coder module for coding a current block relative to at least one block that has previously been coded and then decoded, the module being referenced MCP; and
an entropy coder module for coding said current block by using at least one symbol appearance probability calculated for said previously coded and then decoded block, the module being referenced MCE.

The predictive coder module MCP is a module that is suitable for performing predictive coding of the current block, using conventional prediction techniques, such as for example in intra and/or inter mode.

The entropy coder module MCE is of the CABAC type, but it is modified in accordance with the present invention, as described below in the present description.

In particular, the modifications made to the entropy coder module MCE are based on the teaching of the document by Thomas Wiegand, Gary J. Sullivan, Gisle Bjontegaard, and Ajay Luthra, “Overview of the H.264/AVC video coding standard”, IEEE Transactions on Circuits and System for Video Technology, Vol. 13, No. 7, pp. 560-576, July 2003. In that document, it is specified that the CABAC entropy coder has the feature of allocating a non-integer number of bits to each symbol in a current alphabet for coding. Specifically, the CABAC coder waits until it has read a plurality of symbols, and then it allocates a predetermined number of bits to this set of symbols that have been read, with the coder writing the bits into the compressed stream for transmitting to the decoder. Such a provision thus makes it possible to share bits over a plurality of symbols and to code a symbol on a fractional number of bits, which number is representative of information that is closer to the information actually conveyed by a symbol. Other bits associated with the symbols that have been read are not transmitted in the compressed stream but are conserved, waiting to be allocated to one or more new symbols read by the CABAC coder so as to enable these other bits to be shared once more. In known manner, the entropy coder proceeds at a given instant to “flush” these non-transmitted bits. In other words, at said given instant, the coder extracts the bits that have not yet been transmitted and writes them into the compressed stream for the decoder. Such flushing takes place, for example, when the last symbol for coding has been read, so as to ensure that the compressed stream does indeed contain all of the bits needed by the decoder for decoding all of the symbols of the alphabet. More generally, the instant at which flushing is performed is determined as a function of the performance and the features specific to a given coder/decoder.

In a variant, the entropy coder module MCE may be a conventional Huffman coder.

In the example shown in FIG. 4, if the current tile for coding is the tile TU₁, for example, the coding unit UC codes the blocks B₁, B₂, B₃ of the first row of the tile TU₁ from left to right. When it reaches the last block B₃ of said first row, it moves on to the first block B₄ of the second row of the tile TU₁. When it reaches the last block B₆ of said second row, it moves on to the first block B₇ of the third row of the tile TU₁ and so on until the last block B₁₅ of the tile TU₁ has been coded.

Scans of types other than that described above could naturally be used. Depending on the applications, the coding unit might not process a succession of rows as explained above, but rather a succession of columns. It is also possible to scan rows or columns in one direction or in an opposite direction.

With reference to FIG. 2A, the fourth coding step C4 comprises producing a number N of bit substreams SF₁, SF₂, . . . , SFⱼ, . . . , SF_{N} representing the processed blocks as compressed respectively by the above-mentioned coding unit UC, together with a decoded version of the processed blocks of each tile TUⱼ. The decoded processed blocks of each of said tiles, written TUD₁, TUD₂, . . . , TUDⱼ, . . . , TUD_{N} are suitable for being reused respectively by the coding unit UC shown in FIG. 3.

With reference to FIG. 3, the step of producing a current substream SFⱼ is performed by a software module MGSF for stream generation that is adapted to produce the data streams, such as bit streams, for example.

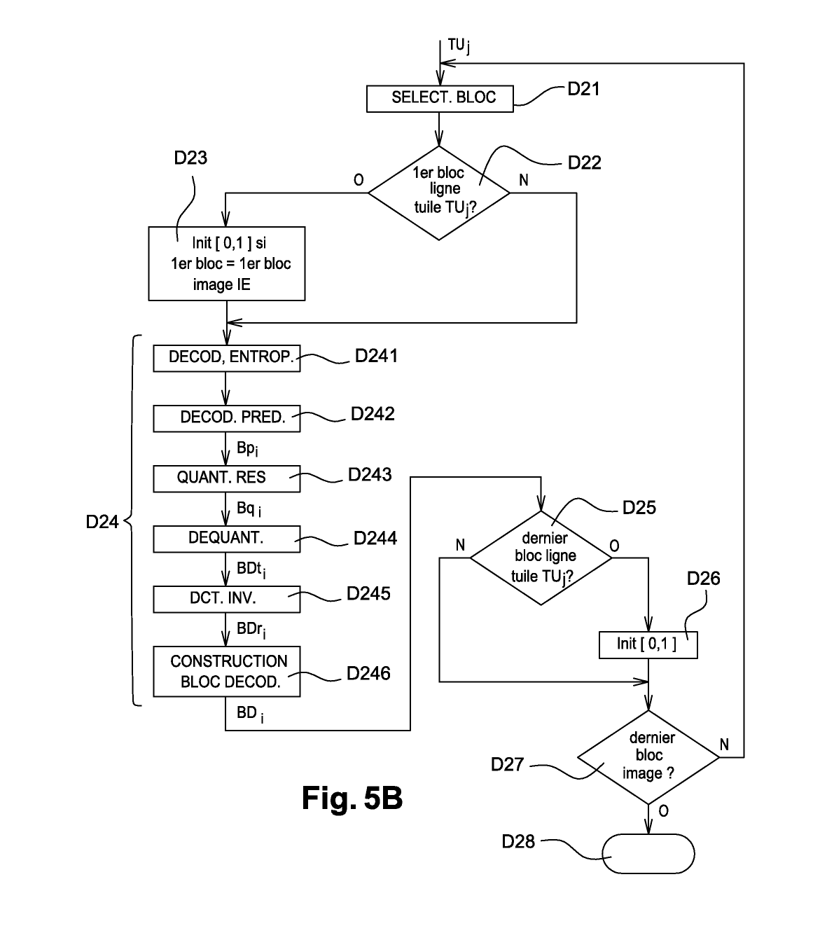

With reference to FIG. 2A, the fifth coding step C5 consists in constructing an overall stream F from the above-mentioned N substreams SF₁, SF₂, . . . , SFⱼ, . . . , SF_{N}. In an implementation, the substreams SF₁, SF₂, . . . , SFⱼ, . . . , SF_{N} are merely juxtaposed in tile order as shown in FIG. 4, together with additional information for informing the decoder of the location of each substream in the overall stream F. The overall stream is then transmitted over a communications network (not shown) to a remote terminal. This terminal includes the decoder DO shown in FIG. 6.

Such construction of the overall stream F is performed in a stream construction module CF, as shown in FIG. 3.

With reference to FIG. 2B, there follows a description of the various substeps that are specific to the invention, as performed during above-specified tile coding step C3 in the coding unit UC.

During a step C31, the coding unit UC selects as the current block the first block for coding in a current tile TUⱼ, such as for example the first tile TU₁ of the image IE shown in FIG. 4.

During a step C32, the coding unit UC tests whether the current block is the first block (situated top left) of a row of the tile TU₁ that was obtained at the end of the above-described step C2.

If so, given the fact that the first block B₁ is also the first block of the image IE, the entropy coder module MCE proceeds during a step C33 with initializing its state variables. In the example shown, which makes use of the above-described arithmetic codings, this consists in initializing an interval representative of the appearance probability of a symbol contained in the predetermined set of symbols. In known manner, this interval is initialized with two bounds L and H, respectively a low bound and a high bound. The value of the low bound L is set to zero, while the value of the high bound is set to 1, which corresponds to the appearance probability of a first symbol from among all of the symbols of the predetermined set of symbols. The size R of this interval is thus defined at this stage by R=H-L=1. The initialized interval is also conventionally partitioned into a plurality of predetermined subintervals that are representative respectively of the appearance probabilities of symbols in the predetermined set of symbols.

In a variant, the initialized internal variables are one of the above-mentioned interval bounds, together with its length.

In another example, if the entropy coding used is LZW coding, then a symbol string translation table is initialized so that it contains all possible symbols once and once only.

During a step C34 that follows the above-described step C33, the first current block B₁ of the first row of the tile TU₁ shown in FIG. 4 is coded. Such a step C34 comprises a plurality of substeps C341 to C348, that are described below.

During a first substep C341, the current block B₁ is subjected to predictive coding using known intra and/or inter prediction techniques, during which the block B₁ is predicted relative to at least one block that has previously been coded and then decoded.

Naturally, it is possible to use intra prediction modes other than those proposed in the H.264 standard.

The current block B₁ may also be subjected to predictive coding in inter mode, during which the current block is predicted relative to a block from a previously coded and decoded image. Other types of prediction may naturally be envisaged. Among the types of prediction possible for a current block, the optimum type of prediction is selected on the basis of a distortion rate criterion that is well known to the person skilled in the art.

Said above-mentioned predictive coding step serves to construct a predicted block Bp₁ which is an approximation of the current block B₁. The information relating to the predictive coding is subsequently written in the stream F that is transmitted to the decoder DO. Such information comprises in particular the type of prediction (inter or intra), and where appropriate, the intra prediction mode, the type of partitioning used for a block or a macroblock if the macroblock has been subdivided, and the index of the reference image together with the motion vector used in the inter prediction mode. This information is compressed by the coder CO shown in FIG. 3.

During a following substep C342, the predictive block Bp₁ is subtracted from the current block B₁ in order to produce a residue block Br₁.

During a following substep C343, the residue block Br₁ is transformed using a conventional direct transform operation, such as for example a discrete cosine transform (DCT) in order to produce a transformed block Bt₁.

During a following substep C344, the transformed block Bt₁ is quantified using a conventional quantification operation, such as for example scalar quantification. This produces a quantified coefficients block Bq₁. During a following substep C345, entropy coding is performed on the quantified coefficients block Bq₁. In the preferred implementation, this is done using CABAC entropy coding. Such a step consists in:
reading the symbol(s) of the predetermined set of symbols that are associated with said current block; and
associating digital information, such as bits, to the symbol(s) that has/have been read.

In the above-mentioned example in which the coding used is LZW coding, digital information relating to the code of the symbol in the current translation table is associated with the symbol for coding, and the translation table is updated, using a known method.

During a following substep C346, the block Bq₁ is subjected to dequantification in a conventional dequantification operation, which is the operation that is the inverse of the quantification performed in step C344. This produces a dequantified coefficients block BDq₁.

During a following substep C347, the inverse transform is applied to the dequantified coefficients block BDq₁, where this operation is the inverse of the direct transform in above-mentioned step C343. A decoded residue block BDr₁ is thus obtained.

During a following substep C348, the decoded block BD₁ is constructed by adding the decoded residue block BDr₁ to the predictive block Bp₁. It should be observed that the decoded residue block is the same as the decoded block obtained at the end of the method of decoding the image IE as described below. The decoded block BD₁ is thus made available for use by the coding unit UC.

At the end of the above-mentioned coding step C34, the entropy coder module MCE as shown in FIG. 3 contains all of the probabilities as progressively updated during the coding of the first block. These probabilities correspond to the various possible syntax elements and to the various associated coding contexts.

The coding step C34 is also performed directly if, at the end of above-mentioned step C32, the current block is not the first block of a row of the tile TU₁.

During a following step C35, the coding unit UC tests whether the current coded/decoded block is the last block of a row of the tile TU₁. With reference to FIG. 4, such a step consists in verifying whether the right-hand side of the current block touches the edge of the boundary FR₁ that is adjacent to the edge of the boundary FR₂.

If the current block that has been coded/decoded is the last block of a row of the tile TU₁, i.e. with reference to FIG. 4, if it is found that the current block B₃ has its right-hand side along the edge B₁T₁ of the tile TU₁ that forms a portion of the boundary FR₁ with the edge B₁T₂ of the second tile TU₂, the coding unit UC of FIG. 3 acts during a following step C36 to flush bits, as mentioned above in the description. For this purpose, the coding unit UC transmits to the substream generator module MGSF all of the bits that have been associated with the symbol(s) read during the coding of each block of the row of the tile TU₁ under consideration, so that the module MGSF writes all of said bits into the data substream SF₁ shown in FIG. 4 and containing a binary string representative of the coded blocks of said row. Such flushing is represented in FIG. 4 by a triangle at the end of each tile row.

During a step C37, the coding unit UC performs a step identical to above-mentioned step C33, i.e. it initializes once more the interval representative of the appearance probability of a symbol contained in the predetermined set of symbols.

The advantage of performing the steps C36 and C37 at this stage of coding is that when the coding unit UC is coding the following block, the coder CO is in an initialized state. Thus, as described below, it becomes possible for a decoding unit to decode the compressed stream F directly from this point, since it suffices for it to be in the initialized state.

During a following step C38, the coding unit UC tests whether the current block that has just been coded/decoded is the last block of the image IE.

The step C38 is also performed when the current block that has been processed at the end of above-mentioned step C34 is not the last block of a row of the current tile following test step C35.

If the current block is the last block of the image IE, the current coding method is ended in a step C39.

Otherwise, the following block for coding is selected in application of the raster-scan order for the tile TU₁ and the steps C31 et seq. are reiterated. In the example shown in FIG. 4, this is the block B₂.

The above-described coding method is performed for all of the rows that are to be coded in a tile under consideration.

### Detailed Description of an Implementation of the Decoding Portion

An implementation of the decoding method of the invention is described below in which the decoding method is implemented in software or hardware form by modifying a decoder that was initially in compliance with the H.264/MPEG-4 AVC standard.

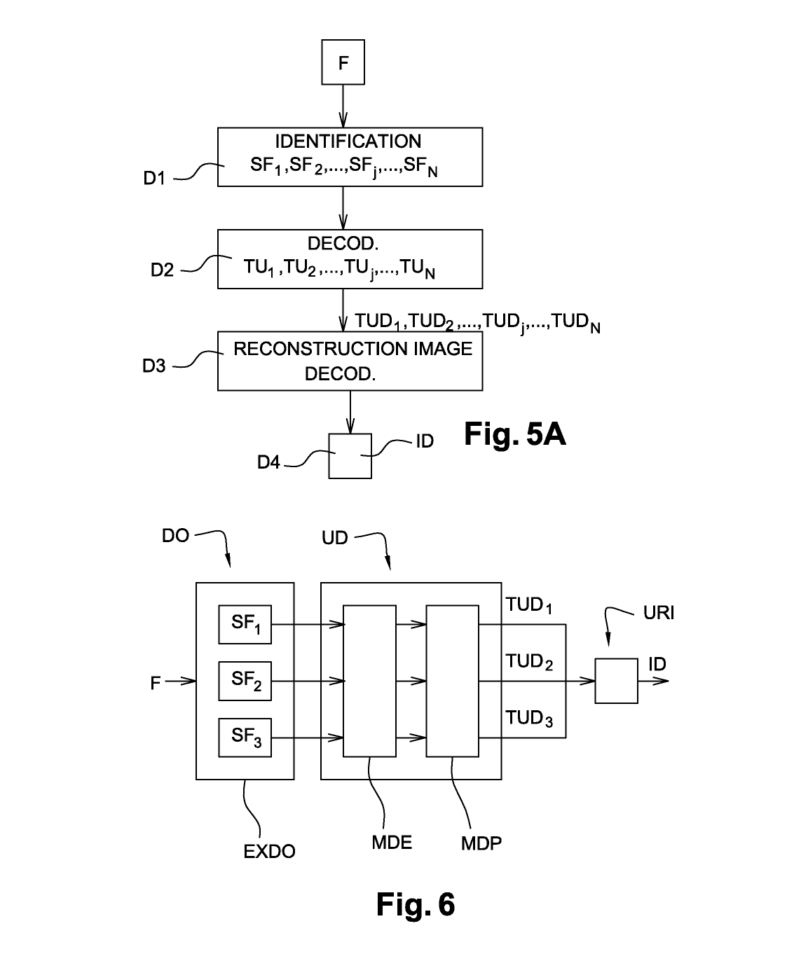

The decoding method of the invention is shown in FIG. 5A in the form of an algorithm having steps D1 to D4.

In an embodiment of the invention, the decoding method of the invention is implemented in a decoder device DO shown in FIG. 6.

With reference to FIG. 5A, the first decoding step D1 comprises identifying in said stream F the N substreams SF₁, SF₂, . . . , SFⱼ, . . . , SF_{N} respectively containing the N tiles TU₁, TU₂, . . . , TUⱼ, . . . , TU_{N} of blocks B₁, B₂, . . . , Bᵢ, . . . , B_{K}, with 1≦i≦K that have previously been coded, as shown in FIG. 4. For this purpose, each substream SF₁, SF₂, . . . , SFⱼ, . . . , SF_{N} in the stream F is associated with an indicator for enabling the decoder DO to determine the location of each substream in the stream F.

In the example shown in FIG. 4, said blocks are square in shape and they are all of the same size.

Depending on the size of the image, which size is not necessarily a multiple of the size of the blocks, the last blocks to the left and the last blocks at the bottom need not be square. In an alternative implementation, the blocks may for example be rectangular in shape and/or they need not be in alignment with one another.

Each block or macroblock may also itself be divided into subblocks, that may themselves be subdivided.

Such identification of substreams is performed by a stream extraction module EXDO as shown in FIG. 6.

With reference to FIG. 5A, the second decoding step D2 comprises decoding each of said tiles TU₁, TU₂, . . . , TUⱼ, . . . , TU_{N}, so as to deliver N respective decoded tiles of blocks TUD₁, TUD₂, . . . , TUDⱼ, . . . , TUD_{N}.

The tiles of blocks are decoded by a single decoding unit UD as shown in FIG. 6.

As shown in greater detail in FIG. 6, the decoding unit UD comprises:
an entropy decoder module MDE for decoding said current block by learning at least one symbol appearance probability calculated for at least one previously decoded block; and
a predictive decoder module MDP for decoding a current block relative to said previously decoded block.

The predictive decoder module MDP is suitable for performing predictive decoding of the current block using conventional prediction techniques, such as for example in intra and/or inter mode.

The entropy decoder module MDE is of the CABAC type, but it is modified in accordance with the present invention as described below.

In a variant, the entropy decoder module MDE could be a conventional Huffman decoder.

In the example shown in FIG. 4, if the current tile for decoding is the tile TU₁, for example, then the unit UD decodes the blocks B₁, B₂, B₃ of the first row of the tile TU₁ from left to right. On reading the last block B₃ of said first row, it moves on to the first block B₄ of the second row of the tile TU₁. On reading the last block B₆ of said second row, it moves on to the first block B₇ of the third row of the tile TU₁ and so on until it has decoded the last block B₁₅ of the tile TU₁.

Scans of types other than that described above could naturally be used. Depending on the application, the decoding unit UD, instead of processing a succession of rows as explained above, could process a succession of columns. It is also possible to scan the rows or the columns in one direction or the other.

With reference to FIG. 5A, the third decoding step D3 is reconstructing a decoded image ID using each of the decoded tiles TUD₁, TUD₂, . . . , TUDⱼ, . . . , TUD_{N} obtained from the decoding step D2. More precisely, the decoded blocks of each decoded tile are transmitted to an image reconstruction unit URI as shown in FIG. 6. During this step D3, the unit URI writes the decoded blocks in a decoded image progressively as these blocks become available.

During a fourth decoding step D4 shown in FIG. 5A, the fully decoded image ID is delivered by the unit URI as shown in FIG. 6.

With reference to FIG. 5B, there follows a description of the various substeps that are specific to the invention, as performed during the above-mentioned decoding step D2 in the decoding unit UD.

During a step D21, the decoding unit UD selects as the current block in the corresponding substream the first block for decoding in a current tile TUⱼ, such as for example the first tile TU₁ of the image IE shown in FIG. 4.

During a step D22, the decoding unit UD tests whether the current block is the first block (situated top left) of a row of the tile TU₁, specifically the first block B₁ of the substream SF₁.

If it is, given the fact that the first block B₁ is also the first block of the image IE, the entropy decoder module MDE acts during a step D23 to initialize its state variables. In the example shown, this comprises initializing an interval representative of the appearance probability of a symbol contained in the predetermined set of symbols.

In a variant, if the entropy decoding used is LZW decoding, then a symbol string translation table is initialized, so that it contains all possible symbols once and once only. Since the step D23 is identical to the above-described coding step C33, it is not described in greater detail.

During a step D24, that follows the above-described step D23, the first current block B₁ of the first row of the tile TU₁ shown in FIG. 4 is subjected to decoding. Such a step D24 comprises a plurality of substeps D241 to D246 that are described below.

During a first substep D241, the syntax elements associated with the current block are subjected to entropy decoding by reading the stream F with the help of a stream pointer P. Such a step consists mainly:
in reading the bits contained at the beginning of the substream SF₁ associated with the first coded block B₁; and
in reconstructing the symbols from the bits that are read.

In the above-mentioned variant in which the decoding used is LZW decoding, digital information corresponding to the code of the symbol in the current translation table is read, the symbol is reconstructed from the code as read, and the translation table is updated using a method that is itself known.

More precisely, the syntax elements associated with the current block are decoded by the CABAC entropy decoder module MDE as shown in FIG. 6. This module decodes a first portion of the substream SF₁ of bits of the compressed file in order to produce the syntax elements, and simultaneously, it updates its probabilities so that when it decodes a symbol, the appearance probabilities for the symbol are identical to those that were obtained during coding the same symbol during the above-described entropy coding step C345.

During a following substep D242, predictive decoding of the current block B₁ is performed using conventional intra and/or inter prediction techniques, during which the block B₁ is predicted relative to at least one previously decoded block.

Naturally, it is possible to use intra prediction modes other than those proposed in the H.264 standard.

During this step, predictive decoding is performed with the help of the syntax elements decoded during the preceding step and including in particular the type of prediction (inter or intra), and where appropriate the intra prediction mode, the type of partitioning used for a block or a macroblock if it is has been subdivided, and the index of the reference image together with the motion vector as used in inter prediction mode.

Said above-mentioned predictive decoding step serves to construct a predicted block Bp₁.

During a following substep D243, a quantified residue block Bq₁ is constructed with the help of the previously decoded syntax elements.

During a following substep D244, the quantified residue block Bq₁ is subjected to dequantification using a conventional dequantification operation that is the inverse of the quantification operation performed in the above-described step C344, thereby producing a decoded dequantified block BDt₁.

During a following substep D245, the inverse transform is applied to the dequantified block BDt₁, i.e. an operation is performed that is the inverse of the direct transform performed in above-described step C343. A decoded residue block BDr₁ is thus obtained.

During a following substep D246, the decoded block BD₁ is constructed by adding the decoded residue block BDr₁ to the predicted block Bp₁. The decoded block BD₁, is thus made available for use by the decoding unit UD.

At the end of above-described decoding step D246, the entropy decoder module MDE as shown in FIG. 6 contains all of the probabilities as progressively updated during the decoding of the first block. These probabilities correspond to the various possible syntax elements and to the various associated decoding contexts.

The decoding step D24 is also performed directly if, at the end of above-described step D22, the current block is not the first block of a row of the tile TU₁.

During a following step D25, the decoding unit UD tests whether the decoded current block is identified as being the last block of a row of the tile TU₁.

If the decoded current block is the last block of a row of the tile TU₁, e.g. the block B₃ as shown in FIG. 4, the decoding unit UD of FIG. 6 acts during a step D26 to perform a step identical to above-described step D23, i.e. it initializes once more the interval representative of the appearance probability of a symbol contained in the predetermined set of symbols.

During a following step D27, the decoding unit UD tests whether the current block that has just been decoded is the last block of the image IE, i.e. whether it is the last block of the last substream, namely the substream SF₃ in the example shown in FIG. 4.

Such a step D27 is also performed when the current block that has been decoded at the end of above-described step D24 is not the last block of a row of the current tile following test step D25.

If the decoded current block is indeed the last decoded block of the image IE, then during a step D28, the decoding method is brought to an end.

Otherwise, the following block for decoding from the tile TU₁ is selected in application of the raster-scan order, and steps D21 et seq. are reiterated. In the example shown in FIG. 4, this is the block B₂ contained in the substream SF₁.

The advantage of the above-described initialization step D26 lies in the fact that the decoding unit UD is then in an initialized state each time the pointer P of the stream F of FIG. 4 is in a substream portion SF₁, SF₂, or SF₃ that corresponds to the data of a first coded block of a tile row associated with the substream under consideration, for the purpose of decoding the row.

Such a provision is particularly suitable when it is desired to decode the image IE row of blocks by row of blocks, in particular for displaying the image on a display screen, where such screens generally operate by horizontally scanning rows of pixels.

The decoder unit UD is thus capable of moving the pointer P to the beginning of the substream SF₂ to begin reading the first portion of the substream SF₂ corresponding respectively to the first row of coded blocks B₁₆ to B₁₇ of the second tile TU₂ and for decoding the blocks of this row in application of the above-described decoding method. Once the decoding of the blocks has been performed, the decoding unit UD is then in an initialized state ready for processing the next row of blocks B₁₈ to B₁₉. The decoding unit UD is thus capable of moving the pointer P to the beginning of the substream SF₃ in order to begin reading the first portion of the substream SF₃ corresponding respectively to the first row of coded blocks B₂₆ to B₂₈ of the third tile TU₃ and for decoding the blocks of this row in accordance with the above-described decoding method. Once these blocks have been decoded, the decoding unit UD is in an initialized state in order to process the next row of blocks B₂₉ to B₃₁.

Such a procedure is then reiterated for each row of blocks in the image IE.

Furthermore, given the fact that the decoding unit is reinitialized each time a decoded block lies on the boundary between the tile currently being decoded and the tile that follows in raster-scan order, there is no need, for the purpose of restarting decoding of the second row of blocks of said tile, and once the blocks of the first row of the following tile have been decoded, to perform the following operations:
previously storing the bits that were shared during the decoding of the first row of blocks of said tile for the purpose of decoding blocks that follow the last block of the first row of said tile in raster-scan order;
transferring the shared bits into the current memory of the entropy decoder when restarting decoding of the second row of blocks of the tile.

Although the present disclosure has been described with reference to one or more examples, workers skilled in the art will recognize that changes may be made in form and detail without departing from the scope of the disclosure and/or the appended claims.

1. A coding method for coding at least one image comprising:
cutting up the image into a plurality of blocks suitable for containing symbols belonging to a predetermined set of symbols;
grouping together adjacent pairs of blocks into a predetermined number of partitions of the image that are referred to as tiles, the blocks of a tile under consideration being for coding consecutively;
using an entropy coder module to code each of said tiles of blocks by associating digital information with the symbols of each block of a tile under consideration, said coding step including, for the first block of the image, a substep of initializing state variables of said entropy coder module; and
generating at least one data substream representative of at least one of said coded tiles of blocks;
for at least one tile under consideration of said image, where the current block of said tile is a coded block situated along an edge of said tile forming a boundary with an adjacent edge of a tile neighboring said tile, the method further comprises the following steps:
writing in the substream representative of said tile under consideration all of the digital information that has been associated with the symbols during the coding, for said tile under consideration, of the blocks preceding said current block; and
performing said initialization substep.

2. The coding method according to claim 1, wherein said boundary-forming edge of the tile is vertical.

3. A device for coding at least one image, the device comprising:
means for cutting up the image into a plurality of blocks suitable for containing symbols belonging to a predetermined set of symbols;
means for grouping together adjacent pairs of blocks in a predetermined number of image partitions referred to as tiles the blocks of a tile under consideration being for coding consecutively;
means for coding each of said tiles of blocks, said coding means comprising an entropy coder module suitable for associating digital information with the symbols of each block of a tile under consideration, said coding means including, for the first block of the image, initialization submeans for initializing state variables of said entropy coder module; and
means for generating at least one data substream representative of at least one of said coded tiles of blocks;
for at least one tile under consideration of said image, the device comprises:
write means that, in the event of the current block of said tile being a coded block situated along an edge of said tile forming a boundary with an adjacent edge of a tile neighboring said tile, are activated to write in the substream representative of said tile under consideration all of the digital information that has been associated with the symbols during the coding, for said tile under consideration, of the blocks preceding said current block; said initialization submeans also being activated to reinitialize the state variables of said entropy coder module.

4. (canceled)

5. A non-transmissible computer readable data medium storing a computer program including instructions for executing steps of a coding method, when said program is executed by a computer, wherein the coding method comprises:
cutting up an image into a plurality of blocks suitable for containing symbols belonging to a predetermined set of symbols;
grouping together adjacent pairs of blocks into a predetermined number of partitions of the image that are referred to as tiles, the blocks of a tile under consideration being for coding consecutively;
using an entropy coder module to code each of said tiles of blocks by associating digital information with the symbols of each block of a tile under consideration, said coding step including, for the first block of the image, a substep of initializing state variables of said entropy coder module; and
generating at least one data substream representative of at least one of said coded tiles of blocks;
for at least one tile under consideration of said image, where the current block of said tile is a coded block situated along an edge of said tile forming a boundary with an adjacent edge of a tile neighboring said tile, the method further comprises the following steps:
writing in the substream representative of said tile under consideration all of the digital information that has been associated with the symbols during the coding, for said tile under consideration, of the blocks preceding said current block; and
performing said initialization substep.

6. A method of decoding a stream representative of at least one coded image, the method comprising:
identifying in said stream a predetermined number of data substreams corresponding respectively to partitions of blocks of the image for decoding, which partitions are referred to as tiles, the blocks of a tile under consideration being image blocks that are adjacent in pairs and that have been grouped together and then coded consecutively, said blocks being adapted to contain symbols belonging to a predetermined set of symbols; and
decoding said tiles of blocks identified by means of an entropy decoder module, by reading digital information in at least one of said identified substreams, which digital information is associated with the symbols of each block of the tile corresponding to said at least identified substream, said decoding step including, for the first block to be decoded of the image, an initialization substep of initializing state variables of said entropy decoder module;
for at least one substream for decoding corresponding to at least one tile of said image, in the event of the current block of said tile being a block previously decoded and identified as being situated along an edge of said tile forming a boundary with an adjacent edge of a tile adjacent to said tile, performing said initialization substep.

7. A decoding method according to claim 6, wherein said boundary-forming edge of the tile is vertical.

8. A device for decoding a stream representative of at least one coded image, the device comprising:
means for identifying in said stream a predetermined number of data substreams corresponding respectively to partitions of blocks of the image for decoding, which partitions are referred to as tiles, the blocks of a tile under consideration being image blocks that are adjacent in pairs that have been grouped together and then coded consecutively, said blocks being adapted to contain symbols belonging to a predetermined set of symbols; and
decoder means for decoding said identified tiles of blocks, said decoding means comprising an entropy decoder module suitable for reading in at least one of said identified substreams digital information associated with the symbols of each block of said tile corresponding to said at least one identified substream, said decoder means including, for the first block for decoding of the image, initialization submeans for initializing state variables of said entropy decoder module;
wherein for at least one substream for decoding corresponding to at least one tile of said image, in the event of the current block of said tile being a block that has been previously decoded and identified as being situated along an edge of said tile forming a boundary with an adjacent edge of a tile adjacent to said tile, said initialization submeans are activated to reinitialize the state variables of said entropy decoder module.

9. (canceled)

10. A non-transmissible computer readable data medium storing a computer program including instructions for executing steps of method of decoding a stream representative of at least one coded image, when said program is executed by a computer, the method comprising:
identifying in said stream a predetermined number of data substreams corresponding respectively to partitions of blocks of the image for decoding, which partitions are referred to as tiles, the blocks of a tile under consideration being image blocks that are adjacent in pairs and that have been grouped together and then coded consecutively, said blocks being adapted to contain symbols belonging to a predetermined set of symbols; and
decoding said tiles of blocks identified by means of an entropy decoder module, by reading digital information in at least one of said identified substreams, which digital information is associated with the symbols of each block of the tile corresponding to said at least identified substream, said decoding step including, for the first block to be decoded of the image, an initialization substep of initializing state variables of said entropy decoder module;
for at least one substream for decoding corresponding to at least one tile of said image, in the event of the current block of said tile being a block previously decoded and identified as being situated along an edge of said tile forming a boundary with an adjacent edge of a tile adjacent to said tile, performing said initialization substep.
